(19) United States
(12) Patent Application Publication
(10) Pub. No.: US 2004/0144081 A1
(43) Pub. Date: Jul. 29, 2004

(54) Engine exhaust system

(76) Inventor: James W. Lacy, Loma Linda, CA (US)

Correspondence Address: Boniard I. Brown, #113, 1500 West Covina Parkway, West Covina, CA, 91790-2793, US

(21) Appl. No.: 10/758,839

(22) Filed: Jan. 16, 2004

Related U.S. Application Data
(60) Provisional application No. 60/441,229, filed on Jan. 21, 2003.

(51) Int. Cl. F01N 3/00; F02M 25/07

(52) U.S. Cl. 60/278; 60/289

(57) ABSTRACT

A two-stroke engine has a plenum chamber communicating with a retro-tube and exhaust port, an air tube communicating with the plenum chamber, an exhaust tube communicating with the retro-tube, combined flow produced by exhaust inertia urging the exhaust to the end of the retro-tube, and at the bottom of the piston stroke exaust and fresh air exit the retro-tube, then reverse flow and are slowed in reverse direction into the cylinder to increase air density in the engine.

Reference is made to my Provisional Application No. 60/441,229, filed Jan. 21, 2003, entitled “Engine Exhaust System.”

### BACKGROUND

The present invention involves utilization of two major principles, these being (A) the “blowerless” principle, which is the use of exhaust energy to draw air into the combustion cylinder, and (B) the retro-flow principle which is a reverse flow of air back through an exhaust outlet tube and into the cylinder.

Historically, the blowerless principle has been used in experimental engines as the sole source of scavenging air. Other two-stroke engines also now use the principle, but only to augment the pressure difference. The retro-flow principle, so far as can be determined, has not heretofore been discovered and exploited.

Heretofore, there have been many attempts to design and provide a two-stroke engine which is not dependent for its combustion air upon crankcase air pumping or a blower. Although certain of these attempts have succeeded, in each case the engine speed range was quite limited, and long bulky pipes were required to provide air intake.

The present invention provides a new way to scavenge two-stroke engines, and in addition provides a new type of operation comprising an internal cooling of the engine cylinder and the piston.

The invention provides simplicity of manufacture, and a high degree of reliability.

Atmospheric air is drawn through intake ports into the cylinder due to the lowered pressure produced by the rapid exit of exhaust gases. Early experiments have shown this to occur, but a relatively long pipe was required and the engine(s) had an inferior speed range.

Recent experiments have uncovered a new way to draw air into the engine. Besides the initial draw through intake ports, at a later point in the cycle there is a reverse air flow back into the exhaust tube. This principle was discovered by noting the unusually cool temperature of the outlet tube, and conducting other follow-up experiments.

The blowerless principle utilized with the present invention provides the following advantages and results:

1. As crankcase air pumping is no longer required, pressure lubricated journal bearings can be used.

2. There is a great reduction of oil loss and raw fuel loss out the exhaust ports.

3. There is greater available horsepower because no shaft power is used for pumping air.

4. For the reason in #3, there is lower fuel consumption.

5. Fewer engine parts mean a lighter, simpler, cheaper engine.

6. A single-piece crankshaft can be used, with higher unit bearing loads, longer bearing life, and elimination of expensive roller bearings.

7. No separate air pumping chambers in the crankcase are needed for multi-cylinder engines.

8. Due to lack of oil mist lube, spark plug fouling and muffler oil-clogging are almost entirely eliminated.

9. Reed valves or rotary valves at the intake are not needed.

10. Combustion air temperature is lower because it has not been compressed by a blower or crankcase pumping.

Retro-flow cooling provided by the present invention provides the following advantages and results:

1. Engine parts are cooled internally at the very places that have been heated more by outgoing exhaust. This means that there is much less thermal distortion of the pistons and cylinders, which reduces piston seizing and increases reliability and durability.

2. Because the pre-compression temperature of the combustion air is lower, detonation limits are improved, permitting leaner fuel to air ratios, higher compression ratios, and larger displacement cylinders.

3. For the reason above, NOx emissions are reduced due to lower maximum temperatures.

4. Less external cooling is required.

5. Higher continuous power levels can be maintained.

6. Because combustion air is cooler, it is also more dense.

7. The exhaust runs much cooler, so liquid cooling for the exhaust pipe is not needed, construction materials are less critical, and oxidation is reduced or eliminated.

8. Because interior surfaces run cooler, lubrication is superior, speed limits are higher, and piston rings work better because carbon build-up is reduced.

The present invention provides the following illustrative sequence of events in the operation of Applicant's claimed combinations, it being noted that retro-tube volume equals cylinder displacement:

1. At blow-down (exhaust opening) the air already in the retro-tube is pushed out. This is the 1st cylinder displacement volume.

2. Then the exhaust itself passes down past the end of the retro-tube, another cylinder displacement volume.

3. At the same time that event occurs, fresh air is being drawn behind that volume of air into the cylinder through the primary intake ports. The exhaust particle velocity is now almost zero.

4. The flow in the retro-tube reverses, and fresh air from the plenum chamber is drawn into the retro-tube, and its inertia raises the pressure and density of the air already in the cylinder. The low pressure in the cylinder has caused this reversal, having been kept at a low pressure by the descent of the piston to bottom dead center. The sudden closing of the intake ports has also aided the flow reversal.

5. When both ports are closed (internal and external) the piston is moving upward and compression begins.

6. Fuel is injected into the combustion chamber and is ignited before top dead center.

7. The piston descends and blow-down begins at exhaust opening. The stronger the blow-down, the stronger will be the reverse flow.

The retro-tube is heated by exhaust gases or 30° of crank rotation, and cooled by fresh air for 330°.

Fresh air pushing into the cylinder via the retro-tube cools the piston crown where it was heated by hot gases on the exhaust side.

The engine is scavenged by a method which does not require compressed air, and is internally cooled by a method which does not require shaft power. eliminate crankcase pumping of air or to eliminate a blower, to decrease lubricating oil loss and exhaust pollution, to simplify the construction of two-stroke engines, and to augment the cooling of two-stroke engines.

The purpose of the separator is to prevent the mixing of secondary air and exhaust.

1. The flow out the end of the retro-tube is fairly compact, that is, it does not diverge very much. So another tube, slightly larger, is located just opposite the outlet, about one diameter apart from it. The entry edges of this second tube are rounded so the exhaust gases can be guided back into this second tube.

2. The flow of secondary fresh air into the outlet tube is radially convergent, so there is sufficient space between the two opposite tubes for the air to pass through. The entry of fresh air into the outlet is improved by a slight rounding of the edges of the tube, as the air is accelerating in velocity as it approaches its entry.

3. To reduce the sound level of the engine, a muffler is attached to the exhaust outlet, and another muffler is attached to the secondary air inlet, as the exhaust noise passes just as easily out the air inlet as it does out the exhaust. This second muffler can be made of materials other than metal, as it operates at a low temperature.

Reverse flow does occur in the retro-tube:

1. When a relatively large chamber with an exhaust outlet is mounted on the retro-tube outlet, and the fresh air in the chamber becomes increasingly diluted by exhaust gases, the engine will slow, then stop. This proves that the engine depends on a reverse flow of fresh secondary air to run properly.

2. When this reverse flow occurs, then its inertia provides some increase in the charge density of air already in the cylinder, increasing the power of the engine.

3. In order for the reverse airflow of secondary air to reach the exhaust port, at least two displacement volumes of gas have to have been exhausted out the retro-tube; first, relatively fresh air left over from the preceding cycle, and then the exhaust itself. Then the reverse flow provides part or all of another, third displacement volume of air to the exhaust port.

4. If this exhaust system cools the retro-tube (and it does), then it must also be cooling the interior of the engine: the cylinder, the combustion chamber, and especially the edge of the piston closest to the exhaust port.

5. The optimum volume of the retro-tube is equal to the total displacement volume swept by the piston in one stroke.

### BRIEF DESCRIPTION OF THE DRAWINGS.

FIG. 1 is a perspective view of a preferred embodiment of the invention;

FIG. 2 is an elevational sectional view of the engine embodiment of FIG. 1;

FIG. 3 is an elevational view similar to that of FIG. 2 showing the components in successive positions of operation;

FIG. 4 is an elevational view similar to that of FIGS. 2 and 3 and showing the engine in a successive position of operation;

FIG. 5 is an elevational view similar to that of FIGS. 3 and 4 showing gas flow in a successive position of engine operation; and

FIG. 6 is an elevational view similar to FIGS. 2 through 5 showing the engine at a later stage of operation.

### DESCRIPTION OF THE PREFERRED EMBODIMENT

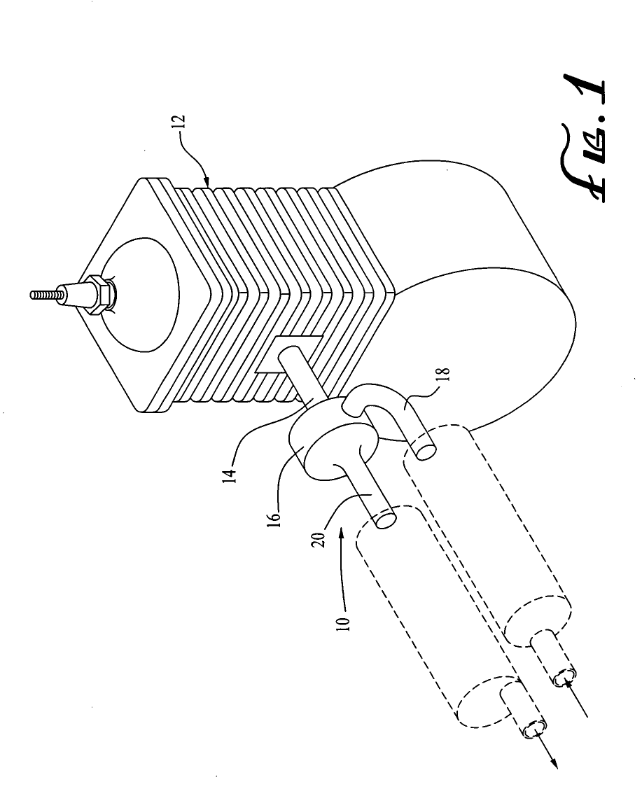

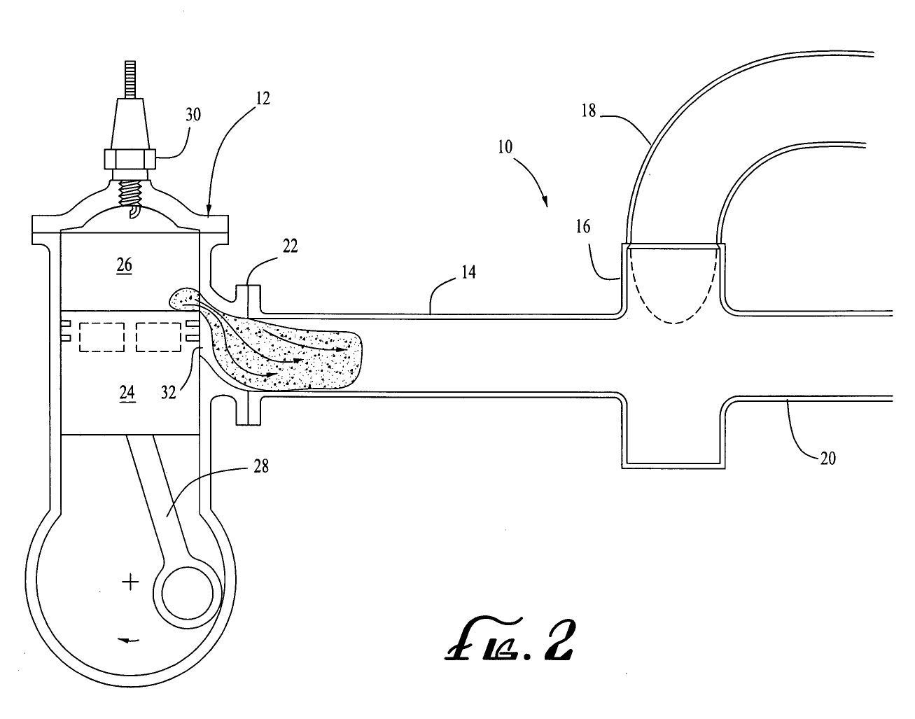

Referring to the drawings, FIGS. 1 and 2 show a preferred embodiment 10 of the invention assembled with a conventional two-stroke engine 12.

The apparatus of the invention comprises a retro-tube 14, a plenum chamber 16 connected with the retro-tube, a secondary air tube 18 communicating with the plenum chamber, and an exhaust receiver tube 20.

In the cycle of operation, upon combustion and piston displacement, exhaust gases pass outwardly via retro-tube 14 which is connected at 22 with the engine exhaust exit port 32. The combined flow produced by the exhaust inertia and kinetic energy enables the exhaust to reach the end of the retro-tube 14.

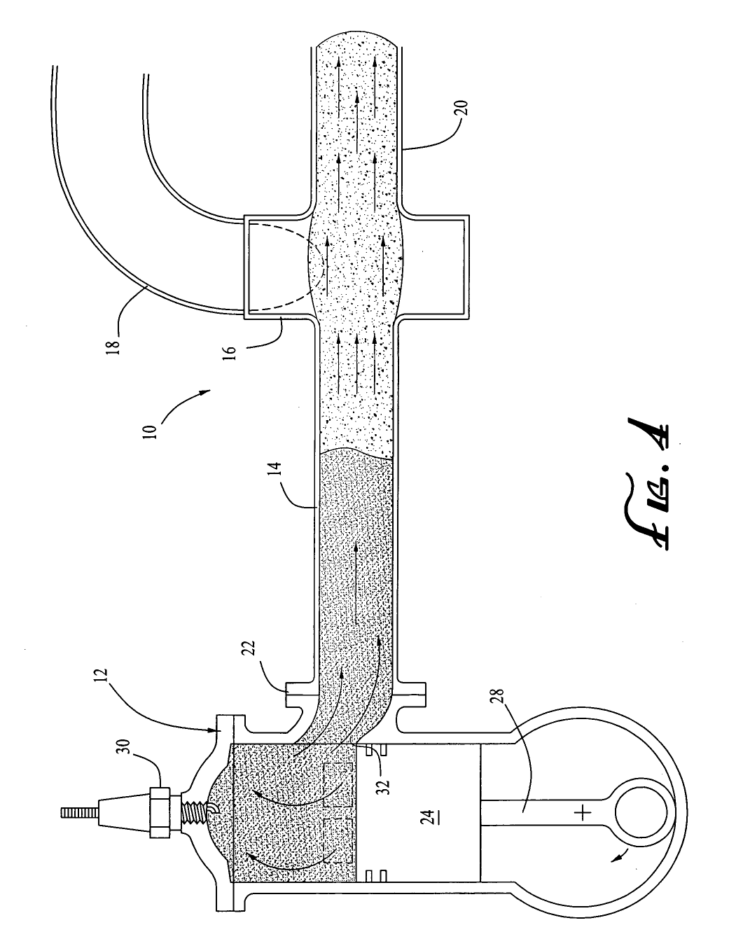

FIG. 4 shows the engine cylinder 26 and adjacent spark plug 30, the cylinder being substantially filled with fresh air, the piston 24 having reached the bottom of its stroke, piston rod 28 being vertical and with excess air approaching the end of the retro-tube 14.

The exhaust and the fresh air therewith exit the retro-tube 14 until they reverse their direction of flow. That is, the engine exhaust and refresh air exit the tube or move through the tube until they slow, whereupon their flow direction reverses and passes back through the exhaust outlet and into the cylinder. The inertia of the fresh air and exhaust increases the pressure and density of the air in the engine cylinder in a kinetic super-charging effect. (It is known in the prior art to use exhaust energy to draw air into an engine cylinder as a means of scavenging air.)

The exhausting of gases into the tube, rather than to atmosphere, increases the vacuum which is produced inside the engine. More air is drawn into the cylinder, the piston stroke continuing to about 90° of rotation, and vacuum in the retro-tube draws in a quantity of clean air into the retro-tube.

With the exhaust system cooling the retro-tube, it also cools the engine interior (combustion chamber) and the edge of the piston closest to the exhaust opening. The optimum volume of the retro-tube equals the total displacement volume of a piston in one stroke.

FIG. 2 illustrates a stage of operation wherein exhaust port 32 is open and exhaust is flowing into retro-tube 14.

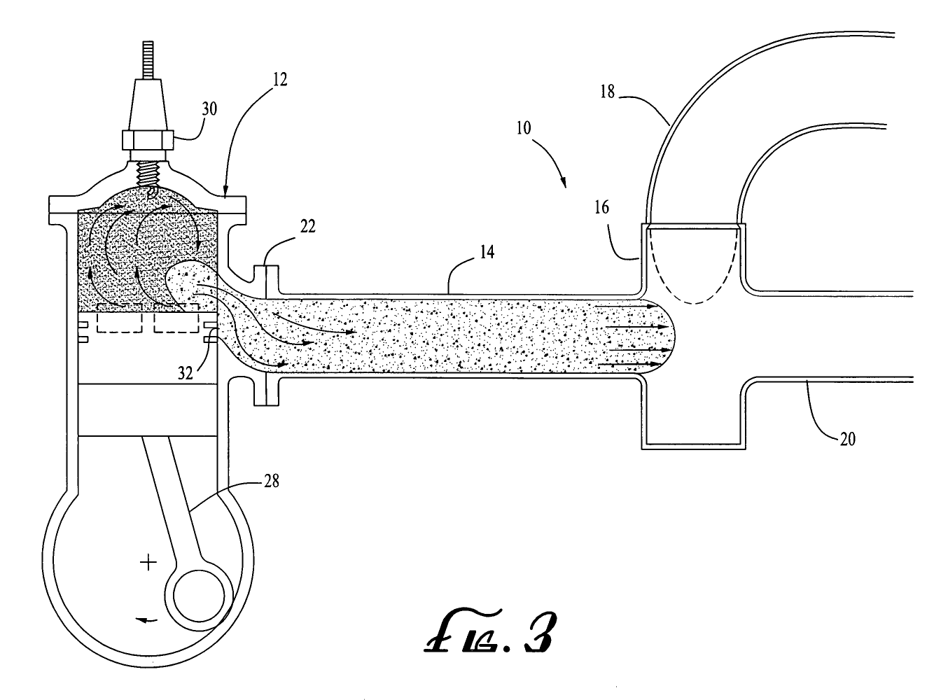

FIG. 3 shows exhaust flowing into the retro-tube 14 and pushing air thereahead. FIG. 3 shows the exhaust having reached the end of the retro-tube 14, and the exhaust gases having left the retro-tube 14. The intake ports are shown as having just opened, with air being drawn therethrough into the engine cylinder for rapid exit of exhaust with lower pressure therebehind, the kinetic energy of the exhaust air drawing air behind itself.

Referring to FIG. 4, the engine cylinder is shown as substantially filled with fresh air, and the piston having reached the bottom of its stroke, with air, etc., having almost reached the outer end of retro-tube 14, the gases having largely exited the plenum chamber and passed into the exhaust chamber tube.

The outlet tube conducts exhaust gases outwardly and conducts fresh air inwardly, in sequence. Therefore, means are provided to separate the two gases. The exhaust gases at the end of the tube leave the tube in a fairly compact form, similar to a solid plug, and are collected by a slightly larger diameter tube opposite the original outlet.

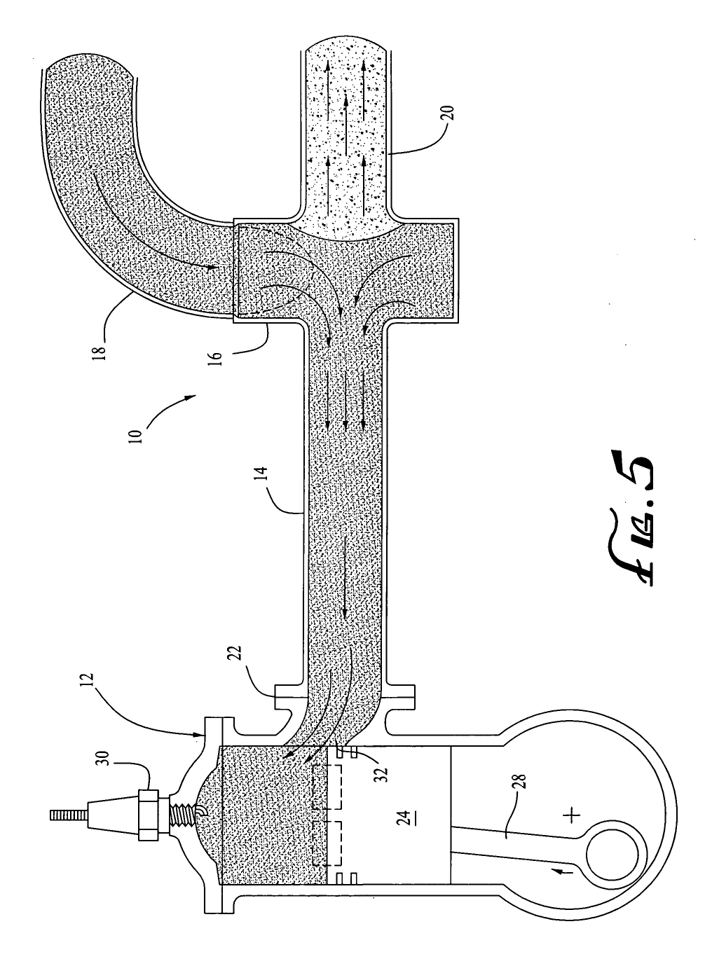

FIG. 5 shows the reverse passing of gases from the plenum chamber 16 via the retro-tube 14 to the combustion chamber.

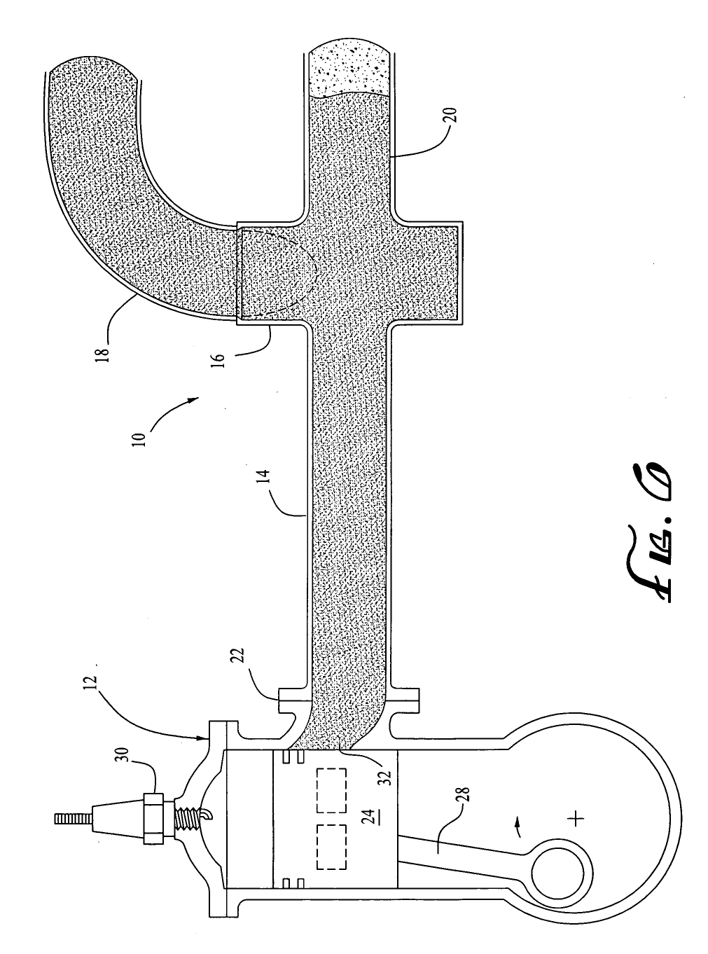

FIG. 6 shows the exit port 32 closed by the piston in its compression stroke, with the gases disposed in the retro-tube 14, plenum chamber 26, secondary air tube 18, and exhaust receiver tube 20.

It will be understood that various changes and modifications may be made from the preferred embodiments discussed above without departing from the scope of the present invention, which is established by the following claims and equivalents thereof.

The inventor claims:

1. A two-stroke engine, comprising:
a retro-tube connected with an exhaust exit port,
a plenum chamber communicating with the retro-tube,
a secondary air tube communicating with the plenum chamber, and
an exhaust receiver tube communicating with the retro-tube, the combined flow produced by exhaust inertia and kinetic energy urging the exhaust to the end of the retro-tube,
upon the piston reaching the bottom of its stroke, the exhaust and fresh air exit the retro-tube, then reverse direction of flow to tube, whereupon they are slowed and their direction of flow is reversed and they pass in reverse through the exhaust outlet and into the cylinder and increase the air density in the cylinder.

2. An engine according to claim 1, wherein inertial inflow of fresh air and exhaust increases the pressure and density of air in the cylinder to provide a kinetic supercharging effect.

3. An engine according to claim 1, wherein air is drawn into the cylinder with the piston stroke continuing to about 90° of rotation, and vacuum in the retro-tube drawing in clean air into the retro-tube.

4. An engine according to claim 1, wherein the exhaust system cools the retro-tube and also cools the combustion chamber and the piston edge adjacent to the exhaust opening.

5. An engine according to claim 1, wherein optimum volume of the retro-tube equals the total displacement volume of a piston stroke.
